(19) United States
(12) Patent Application Publication
(10) Pub. No.: US 2016/0162178 A1
(43) Pub. Date: Jun. 9, 2016

(54) HANDWRITING INPUT DEVICE, NON-TRANSITORY RECORDING MEDIUM STORING COMPUTER READABLE CONTACT BODY DETERMINATION PROGRAM, AND CONTACT BODY DETERMINATION METHOD

(71) Applicant: Konica Minolta, Inc., Tokyo (JP)

(72) Inventors: Yuri FUKUMURA, Hachioji-shi, Tokyo (JP); Kenta HOSAKA, Turumi-ku, Yokohama-shi, Kanagawa (JP); Junichi IMAMURA, Suginami-ku, Tokyo (JP); Keisuke TATEBAYASHI, Hino-shi, Tokyo (JP); Naoyuki INOUE, Hino-shi, Tokyo (JP)

(73) Assignee: Konica Minolta, Inc., Tokyo (JP)

(21) Appl. No.: 14/955,588

(22) Filed: Dec. 1, 2015

(30) Foreign Application Priority Data
Dec. 4, 2014 (JP) 2014-245788
May 12, 2015 (JP) 2015-097489

(51) Int. Cl. G06F 3/0488; G06F 3/043; G06F 3/041

(52) U.S. Cl. CPC G06F 3/04883; G06F 3/0416; G06F 3/0414; G06F 3/043; G06F 2203/04106

(57) ABSTRACT

A handwriting input device includes: a first detection unit that has an input surface to which inputting of information is allowed by direct contact of a contact body or contact of the contact body via a sheet and detects as contact information at least one of contact pressure and contact area of the contact body on the input surface; a second detection unit that detects vibrations generated by the contact as vibration information; and a contact body determination unit that determines the kind of the contact body based on the contact information and the vibration information.

The entire disclosure of Japanese Patent Application No. 2014-245788 filed on Dec. 4, 2014 and Japanese Patent Application No. 2015-097489 filed on May 12, 2015 including description, claims, drawings, and abstract are incorporated herein by reference in its entirety.

### TECHNOLOGICAL FIELD

The present invention relates to a handwriting input device, a computer readable recording medium storing a contact body determination program, and a contact body determination method.

### BACKGROUND

In recent years, there has been proposed a handwriting input device that allows inputting of contents handwritten on an input surface or a paper sheet placed on the input surface by the use of a contact body such as a pen or the like, for example, as electronic data (for example, refer to JP 2007-305109 A (US Patent Publication No. 6055552). The handwriting input device includes a digitizer so that, when writing is done with the pen on a paper sheet placed on the digitizer, for example, the digitizer can detect the pressure of the pen and input the movement locus of the position where the pressure was detected as handwritten data (electronic data).

### DESCRIPTION OF THE RELATED ART

Such a handwriting input device may be required to determine the kind of the contact body (for example, a pen or an eraser) and perform an input process according to the determined kind of the contact body.

JP 2012-108647 A discloses a technique for determining whether a medium (contact body) is a pen, an eraser, or a fingertip based on the size (area) of a space touched by the medium on a touch pad.

JP 2003-519422 A (US Patent Publication No. 7157649) discloses a technique for measuring flexural vibration waves generated when a stylus or a finger touches a contact detection plate and determining whether the contact body is a stylus or a finger.

However, these conventional devices have room for improvement in accuracy of determination of the contact body, compatibility with various kinds of contact bodies, capability of determining the kinds of general-use writing tools, and others.

It is difficult to determine accurately the kind of the contact body only from the size of the space touched by the contact body as described in JP 2007-305109 A (UP Patent Publication No. 6055552). Accordingly, as described in JP 2012-108647 A, an attempt is made to increase the accuracy of determination by providing the contact body with a communication unit transmitting a signal at a press of a button. In this case, however, there arises a problem that it is difficult to determine the kind of a general-use writing tool used as the contact body.

It is contemplated to improve the accuracy of determining the kind of a contact body by detecting the contact pressure and the contact area of the contact body on the input surface to determine the kind of the contact body. In this configuration, however, many contact bodies are similar in contact pressure and contact area, and the kind of the contact body may be incorrectly determined. FIG. 1 is a schematic diagram illustrating the contact pressures and contact areas of several contact bodies on the input surface. As illustrated in FIG. 1, the contact bodies as marker pen, ballpoint pen, highlighter pen, crayon, and eraser overlap partly in contact pressure and contact area on the input surface. Accordingly, when the detected contact pressure and contact area fall within the overlapping range, mis-determination may be made. For example, when the contact pressure is 150 to 200 [gf] and the contact area is 2 to 3 [mm²], it is possible to narrow down the kind of the contact body to ballpoint pen, marker pen, and eraser, but it is not possible to determine finally the actual kind of the contact body.

In addition, it is difficult to determine accurately the kind of the contact body only by measuring flexural vibration waves generated in the contact detection plate as described in JP 2003-519422 A (US Patent Publication No. 7157649). This is because, when a paper sheet is placed on the input surface (contact surface) of the contact detection plate or the user touches the input surface by hand for the purpose of holding the device or the like, the measured flexural vibration waves fluctuate.

### SUMMARY

An object of the present invention is to provide a handwriting input device, a contact body determination program, and a contact body determination method that allow accurate determination on the kind of the contact body.

To achieve the abovementioned object, according to an aspect, a handwriting input device reflecting one aspect of the present invention comprises: a first detection unit that has an input surface to which inputting of information is allowed by direct contact of a contact body or contact of the contact body via a sheet and detects as contact information at least one of contact pressure and contact area of the contact body on the input surface; a second detection unit that detects vibrations generated by the contact as vibration information; and a contact body determination unit that determines the kind of the contact body based on the contact information and the vibration information.

To achieve the abovementioned object, according to an aspect, a handwriting input device reflecting one aspect of the present invention comprises: a first detection unit that has an input surface to which inputting of information is allowed by direct contact of a contact body or contact of the contact body via a sheet and detects as contact information at least one of contact pressure and contact area of the contact body on the input surface; a plurality of second detection units that is arranged at different positions on the input surface and detects vibrations generated by the contact as vibration information; and a contact body determination unit that selects, from among a plurality of pieces of vibration information detected by the plurality of second detection units, two or more pieces of vibration information from two or more of the second detection units different in distance from the contact position of the contact body, according to the contact position of the contact body on the input surface, and determines the kind of the contact body based on the selected two or more pieces of vibration information and the contact information.

To achieve the abovementioned object, according to an aspect, a non-transitory recording medium storing a computer readable contact body determination program reflecting one aspect of the present invention causes a computer to execute: a process for acquiring as contact information at least one of contact pressure and contact area of a contact body on an input surface to which inputting of information is allowed by direct contact of the contact body or by contact of the contact body via a sheet; a process for acquiring vibrations generated by the contact as vibration information; and a process for determining the kind of the contact body based on the contact information and the vibration information.

The non-transitory recording medium storing a computer readable contact body determination program according to an embodiment of the present invention preferably causes a computer to execute: a process for acquiring as contact information at least one of contact pressure and contact area of a contact body on an input surface on which inputting of information is allowed by direct contact of the contact body or by contact of the contact body via a sheet; a process for acquiring a plurality of pieces of vibration information detected by a plurality of second detection units that is arranged at different positions on the input surface to detect vibrations generated by the contact as vibration information; and a process for selecting from among the acquired plurality of pieces of vibration information two or more pieces of vibration information from two or more of the second detection units different in distance from the contact position of the contact body, according to the contact position of the contact body on the input surface, and determining the kind of the contact body based on the selected two or more pieces of vibration information and the contact information.

To achieve the abovementioned object, according to an aspect, a contact body determination method reflecting one aspect of the present invention comprises: detecting as contact information at least one of contact pressure and contact area of a contact body on an input surface to which inputting of information is allowed by direct contact of the contact body or by contact of the contact body via a sheet; detecting vibrations generated by the contact as vibration information; and determining the kind of the contact body based on the contact information and the vibration information.

The contact body determination method according to an embodiment of the present invention preferably includes: detecting as contact information at least one of contact pressure and contact area of a contact body on an input surface on which inputting of information is allowed by direct contact of the contact body or by contact of the contact body via a sheet; acquiring a plurality of pieces of vibration information detected by a plurality of second detection units that is arranged at different positions on the input surface to detect vibrations generated by the contact as vibration information; and selecting from among the acquired plurality of pieces of vibration information two or more pieces of vibration information from two or more of the second detection units different in distance from the contact position of the contact body, according to the contact position of the contact body on the input surface, and determining the kind of the contact body based on the selected two or more pieces of vibration information and the contact information.

### BRIEF DESCRIPTION OF THE DRAWINGS

The advantages and features provided by one or more embodiments of the invention will become more fully understood from the detailed description given hereinbelow and the appended drawings which are given byway of illustration only, and thus are not intended as a definition of the limits of the present invention, and wherein:

FIG. 1 is a schematic diagram showing the possible ranges of contact pressure and contact area of several contact bodies on an input surface;

FIGS. 2A and 2B are schematic views of an entire configuration of a handwriting input device according to an embodiment;

FIG. 3 is a diagram showing main components of a control system in the handwriting input device according to the embodiment;

FIGS. 4A and 4B are diagrams showing a modification example of a layout of vibration detection units in the handwriting input device according to the embodiment;

FIGS. 5A and 5B are diagrams showing a modification example of a layout of vibration detection units in the handwriting input device according to the embodiment;

FIG. 6 is a flowchart of a process for determining the contact body in the handwriting input device according to the embodiment;

FIG. 7 is a diagram describing the procedure in which the list of kinds of the contact body is narrowed down in stages and the actual kind of the contact body is finally determined;

FIGS. 8A to 8C are graphs showing examples of waveforms of vibrations generated by the contact bodies contacting a paper sheet;

FIG. 9 is a diagram showing a sub-routine for determining the kind of the contact body;

FIG. 10 is a graph showing an example of results of Fourier transform on vibrations generated by the contact bodies contacting a paper sheet;

FIG. 11 is a flowchart of a process for adding a contact body in the handwriting input device according to the embodiment;

FIG. 12 is a graph showing an example of results of Fourier transform on vibrations generated by one and the same contact body (pen) contacting a paper sheet;

FIG. 13 is a graph showing an example of results of Fourier transform on vibrations generated by one and the same contact body (eraser) contacting a paper sheet;

FIG. 14 is a diagram showing the arrangement of vibration detection units according to a second embodiment;

FIG. 15 shows the operation of inputting first information by the use of a contact body on an input surface of a touch panel;

FIG. 16 is a flowchart of a process for determining the contact body in the handwriting input device according to the second embodiment; and

FIG. 17 is a graph showing an example of results of Fourier transform on vibrations generated by the same kind of contact bodies with different use histories contacting a paper sheet.

### DESCRIPTION OF THE PREFERRED EMBODIMENTS

Hereinafter, an embodiment of the present invention will be described with reference to the drawings. However, the scope of the invention is not limited to the illustrated examples.

### First Embodiment

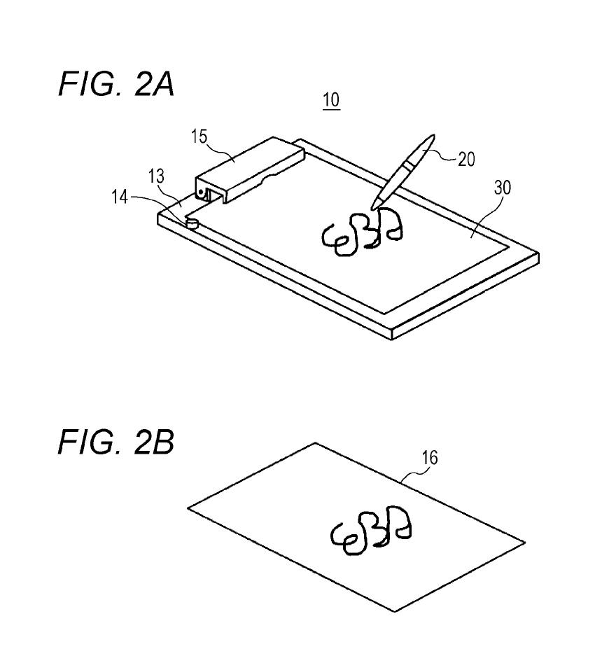

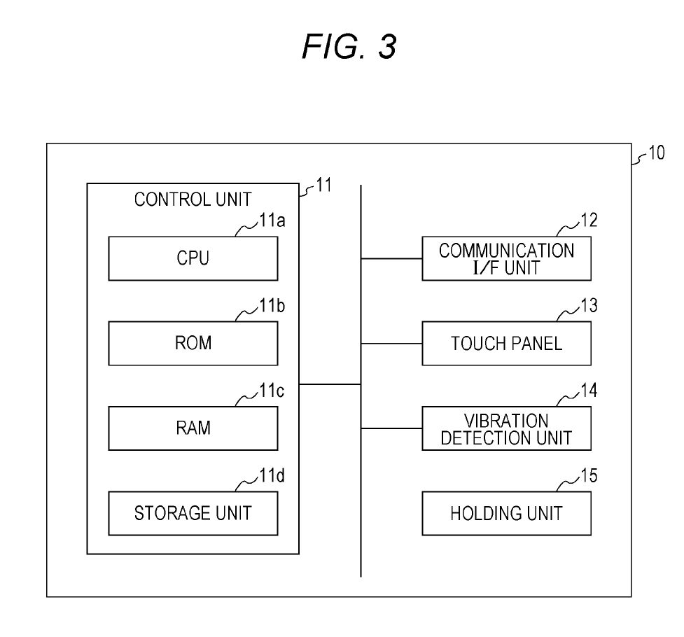

FIGS. 2A and 2B are schematic views of an entire configuration of a handwriting input device 10 according to an embodiment. FIG. 3 shows main components of a control system in the handwriting input device 10 according to the premise technique. The handwriting input device 10 illustrated in FIGS. 2 and 3 includes: a control unit 11 that controls all components; a communication I/F unit 12 that exchanges various kinds of information with an external device; a touch panel 13 as a pressure-sensitive first detection unit; a vibration detection unit 14 as a second detection unit that detects a vibrational wave generated by a contact body 20 (writing tool) used for handwriting by a user and contacting an input surface of the touch panel 13 via a paper sheet 30 as a sheet for writing; and a holding portion 15 such as a clip that holds the input surface of the touch panel 13, i.e. the paper sheet 30 on a placement plane on which the paper sheet 30 can be placed. The contact body 20 may be a ballpoint pen, a marker pen, a highlighter pen, a crayon, or an eraser. The handwriting input device 10 may be configured to produce an output for detecting whether the paper sheet 30 is held on the input surface of the touch panel 13, in conjunction with the degree of opening/closing of the holding portion 15 or by provision of an optical sensor on the holding portion 15, and enter the output into the control unit 11.

As illustrated in FIG. 2A, the user uses the contact body 20 to handwrite something on the paper sheet 30 placed on the touch panel 13. A pressure sensor included in the touch panel 13 detects the pressure of the contact body 20 via the paper sheet 30, and inputs handwritten information 16 indicating the movement locus of the position where the pressure was detected as handwritten data (electronic data) as illustrated in FIG. 2B. While the paper sheet 30 is not placed on the touch panel 13, the user may use the contact body 20 to handwrite something on the input surface of the touch panel 13. In this case, the touch panel 13 also detects directly the pressure of the contact body 20 and inputs the handwritten information 16 indicating the movement locus of the position where the pressure was detected as handwritten data.

The control unit 11 is composed of a CPU (central processing unit) 11a, memories such as a ROM (read only memory) 11b and a RAM (random access memory) 11c, a storage unit 11d such as an HDD (hard disk drive), an SSD (solid state drive), and an SD (secure digital) card. The CPU 11a expands and executes in the RAM 11c control programs including a contact body determination program stored in the ROM 11b and the storage unit 11d to perform entire control of the handwriting input device 10. The RAM 11c also serves as an input buffer to store the handwritten information 16 when handwriting is done on the paper sheet 30. The storage unit 11d stores in advance contact body determination information that includes contact information indicating the contact pressure and the contact area of the contact body 20 on the input surface of the touch panel 13, vibration information indicating the characteristics of vibrations generated by the contact of the contact body 20, and the kinds of contact bodies, in association with one another. The control unit 11 specifies the contents handwritten on the paper sheet 30, from the locus, strength (writing pressure), and range of pressure of the contact body 20 detected by the touch panel 13, under the control programs stored in the storage unit 11d. In the premise technique, the control unit 11 serves as a contact body determination unit that determines the kind of the contact body based on the contact pressure and the contact area of the contact body on the input surface of the touch panel 13 and the vibrations generated by the contact of the contact body.

The communication I/F unit 12 is an NIC (network interface card), a modem, or the like that allows communications with a computer at the transmission destination of the handwritten data in a wired or wireless manner under the standards of Ethernet (registered trademark), NFC (near field communication), Bluetooth (registered trademark), TransferJet (registered trademark).

The pressure-sensitive touch panel 13 is, for example, a digital matrix resistive-film touch panel. The touch panel 13 detects the pressure of the contact body 20 on the paper sheet 30 by the pressure sensor, and receives input of information corresponding to characters and graphics written on the paper sheet 30 according to the user's writing action using the contact body 20. The touch panel 13 detects the contact position, contact pressure, and contact area of the contact body on the input surface of the touch panel 13, and outputs the detected contact position, contact pressure, and contact area as contact information to the control unit 11. The contact information output to the control unit 11 is used in a contact body determination process for determining the kind of the contact body as described later.

In the premise technique, the touch panel 13 is a pressure-sensitive panel, more specifically, a digital matrix resistive-film panel, and therefore can detect a writing action on the paper sheet 30 even by the use of a stylus pen or a finger instead of general writing tools such as a ballpoint pen, a mechanical pencil, or a lead pencil. In the premise technique, the “writing action” refers to not only the action of writing characters, graphics, and the like on the paper sheet 30 by the contact body 20 to input the information corresponding to the characters, graphics, and the like into the handwriting input device 10 via the touch panel 13, but also the action of, at completion of writing of characters, graphics, and the like on the paper sheet 30 using the contact body 20 and an eraser in combination, inputting the information corresponding to the completed characters, graphics, and the like into the handwriting input device 10 via the touch panel 13. In addition, the “writing action” also herein refers to the action of, when erasing characters, graphics, and the like by an eraser from the paper sheet 30, detecting the movement locus of the eraser through the touch panel 13 and erasing the input characters and graphics based on the information corresponding to the input characters and graphics.

The vibration detection unit 14 is a microphone or the like positioned in contact with the input surface of the touch panel 13 (more specifically, at the outside of the paper sheet 30 placed on the input surface of the touch panel 13) as illustrated in FIG. 2A. The vibration detection unit 14 detects vibrations generated by the contact body 20 contacting the paper sheet 30. Specifically, the vibrations generated by the contact body 20 contacting the paper sheet 30 are propagated to the input surface of the touch panel 13, and the vibration detection unit 14 detects the propagated vibrations. Then, the vibration detection unit 14 outputs the detected information as vibration information to the control unit 11. The vibration information output to the control unit 11 is used together with the foregoing contact information in the contact body determination process for determining the kind of the contact body as described later.

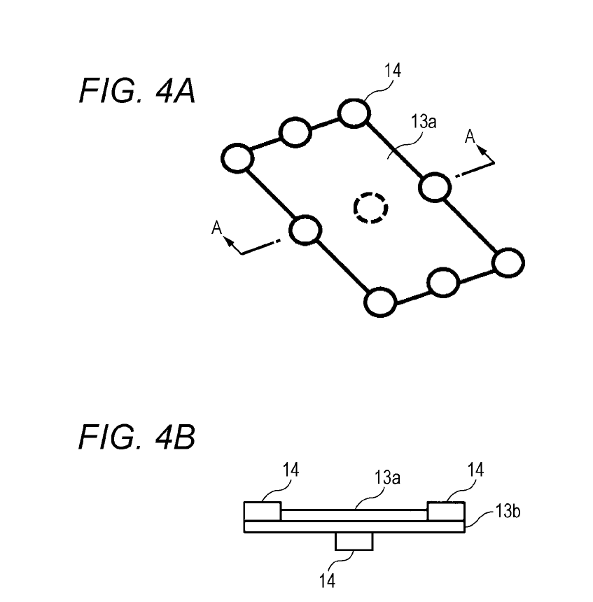

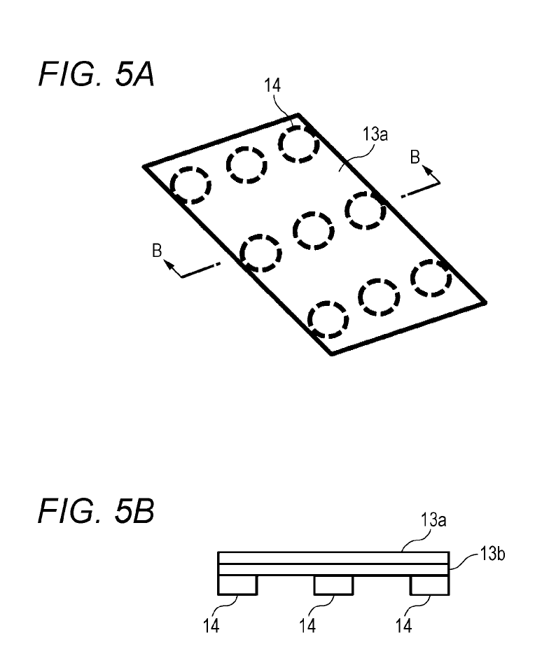

The arrangement of the vibration detection unit 14 is not limited to the arrangement illustrated in FIG. 2A. For example, the vibration detection unit 14 may be positioned in contact with the paper sheet 30 placed on the input surface of the touch panel 13 to detect vibrations generated by the contact body 20 contacting the paper sheet 30. In addition, the number of the vibration detection unit 14 is not limited to one but may be two or more. For example, as illustrated in FIGS. 4A and 4B as a cross-sectional view of FIG. 4A taken along line A-A, eight vibration detection units 14 may be arranged at the outer periphery of an input surface 13a of the touch panel 13, and one vibration detection unit 14 may be arranged on the back side of the input surface 13a, more specifically, at the center of the back surface of a pressure sensor 13b included in the touch panel 13. Alternatively, as illustrated in FIGS. 5A and 5B as a cross-sectional view of FIG. 5A taken along line B-B, nine vibration detection units 14 may be arranged on the back side of the input surface 13a of the touch panel 13, more specifically, at the upper part, the central part, and the lower part of the back surface of the pressure sensor 13b of the touch panel 13. Even when the vibration detection units 14 are arranged on the back surface of the pressure sensor 13b, the vibration detection units 14 can detect vibrations generated by the contact body 20 contacting the paper sheet 30 and propagated to the vibration detection units 14 through the input surface 13a and the pressure sensor 13b.

The holding portion 15 holds the paper sheet 30 on the touch panel 13. More specifically, the holding portion 15 has a rotation shaft at one end fixed to the housing of the handwriting input device 10 and has the other end rotated by a spring and due to the flexibility of the material for the holding portion 15 to press the paper sheet 30. To replace the paper sheet 30, the user lifts and rotates the holding portion 15 while putting a finger into an opening at the other end of the holding portion 15. That is, the user opens and closes the holding portion 15 to hold the upper end and its neighborhood of the paper sheet 30 on the holding portion 15 or replace the paper sheet 30. The holding portion 15 may not be fixed at the one end to the housing of the handwriting input device 10 but may hold the paper sheet 30 on the touch panel 13 by a magnet or the like. In addition, the paper placement surface of the touch panel 13 may be finished to prevent slippage of the paper sheet 30 or may be provided with a sheet-like friction force addition member to prevent the slippage of the paper sheet 30.

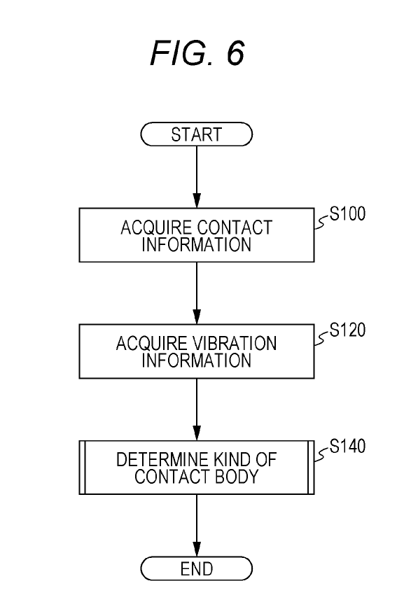

Next, descriptions will be given as to the contact body determination process for determining the kind of the contact body 20 when writing is done by the contact body 20 on the paper sheet 30 placed on the touch panel 13 in the premise technique. FIG. 6 is a flowchart of the contact body determination process executed by the control unit 11 based on the contact body determination program according to the premise technique. This process is executed each time writing is done by the contact body 20 on the paper sheet 30 after power-on of the handwriting input device 10, for example.

First, the control unit 11 acquires the contact information output from the touch panel 13 (step S100).

Then, the control unit 11 acquires the vibration information output from the vibration detection unit 14 (step S120).

Finally, the control unit 11 determines the kind of the contact body 20 based on the contact pressure and the contact area indicated by the contact information acquired at step S100 and the vibrations indicated by the vibration information acquired at step S120 (step S140).

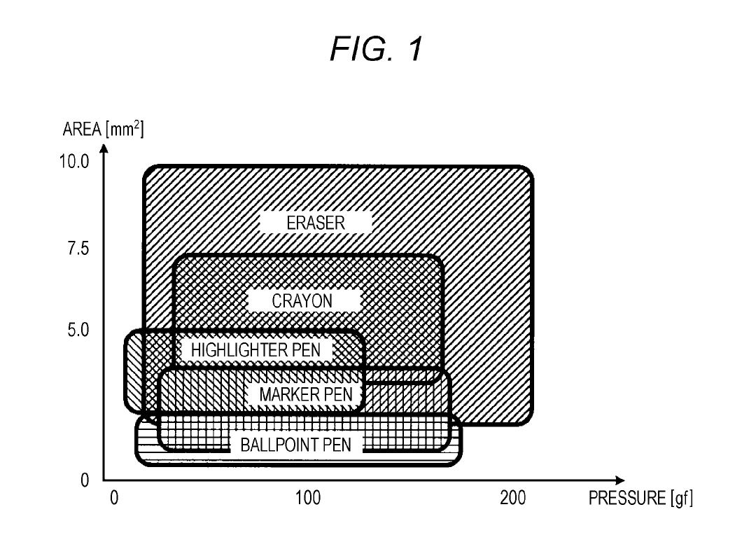

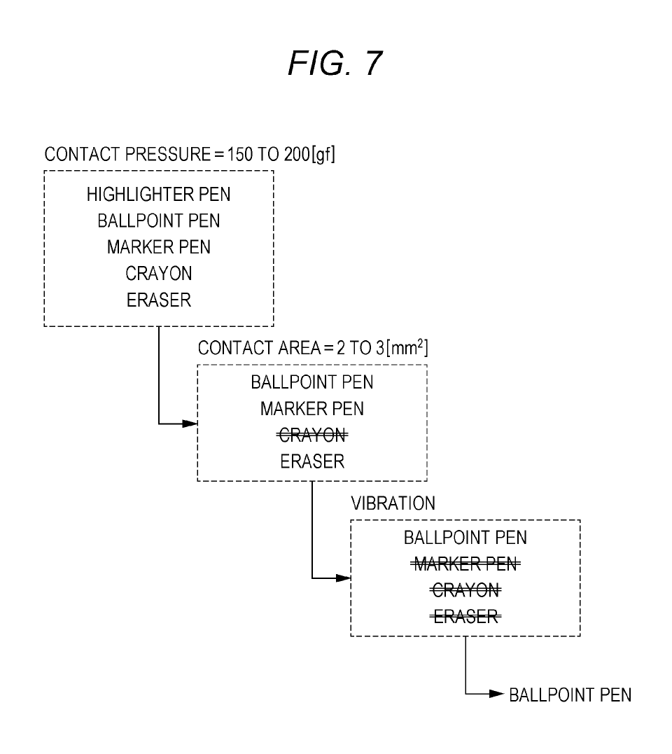

In this embodiment, the control unit 11 narrows down the kind of the contact body 20 in stages using the contact pressure, the contact area, and the vibrations, and finally determines the actual kind of the contact body 20. Hereinafter, an example of the control unit 11 determining the kind of the contact body 20 by narrowing down the kind of the contact body 20 in stages will be described. First, when the contact pressure falls within the range of 150 to 200 [gf], for example, the control unit 11 refers to the contact body determination information stored in the storage unit 11d to determine that the kind of the contact body 20 is the ballpoint pen, the marker pen, the crayon, or the eraser (refer to FIGS. 1 and 7). Since the contact pressure of the highlighter pen on the input surface of the touch panel 13 is out of the range of 150 to 200 [gf], the highlighter pen is not excluded from the kind of the contact body 20 in this stage.

Then, when the contact area falls within the range of 2 to 3 [mm²], the control unit 11 refers to the contact body determination information stored in the storage unit 11d to determine that the kind of the contact body 20 is the ballpoint pen, the marker pen, or the eraser (refer to FIGS. 1 and 7). Since the contact area of the crayon on the input surface of the touch panel 13 is out of the range of 2 to 3 [mm²], the crayon is not excluded from the kind of the contact body 20 in this stage. In addition, the user's finger or hand may be excluded from the kind of the contact body 20 in this stage.

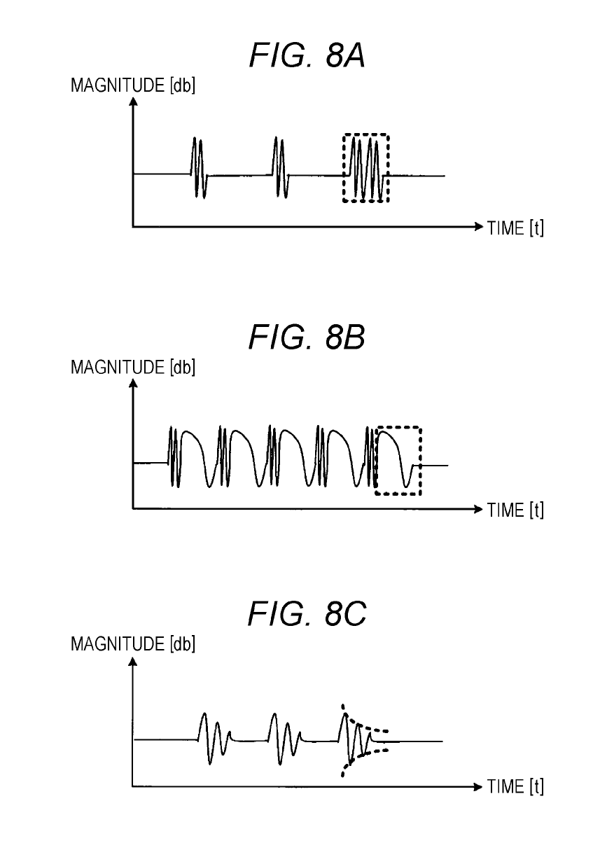

Finally, the control unit 11 refers to the contact body determination information stored in the storage unit 11d and determines finally that the actual kind of the contact body 20 is the ballpoint pen, for example, from the characteristics of waveform of vibrations indicated by the vibration information (see FIG. 7). FIGS. 8A to 8C are graphs in which waveforms of vibrations generated by the contact bodies 20 contacting the paper sheet 30 are plotted on the axes of time and magnitude. FIG. 8A is a graph showing a waveform of vibrations generated by a ballpoint pen as the contact body 20 contacting the paper sheet 30. As indicated by dotted lines in FIG. 8A, when the contact body 20 is a ballpoint pen, the waveform of the vibrations is characterized by fine pitches at regular intervals. FIG. 8B is a graph showing a waveform of vibrations generated by an eraser as the contact body 20 contacting the paper sheet 30. As indicated by dotted lines in FIG. 8B, when the contact body 20 is an eraser, the waveform of the vibrations is characterized by tail-like terminations. FIG. 8C is a graph showing a waveform of vibrations generated by a marker pen as the contact body 20 contacting the paper sheet 30. As indicated by dotted lines in FIG. 8C, when the contact body 20 is a marker pen, the waveform of the vibrations is characterized by gradual attenuations. As described above, the different waveforms of vibrations are generated by the ballpoint pen, the eraser, and the marker pen as the contact bodies 20 because the contact bodies 20 are made from materials different in composition, and when contacting the paper sheet 30 (more specifically, when contacting and moving over the paper sheet 30), the contact bodies 20 act differently on the paper sheet 30 such as sliding on the paper sheet 30, sticking to the paper sheet 30, or slipping on the paper sheet 30 depending on the contact bodies 20. As described above, the waveform of the vibrations indicated by the vibration information is a parameter that clearly varies depending on the contact bodies 20, and therefore the control unit 11 can determine accurately the kind of the contact body 20 by the use of the parameter.

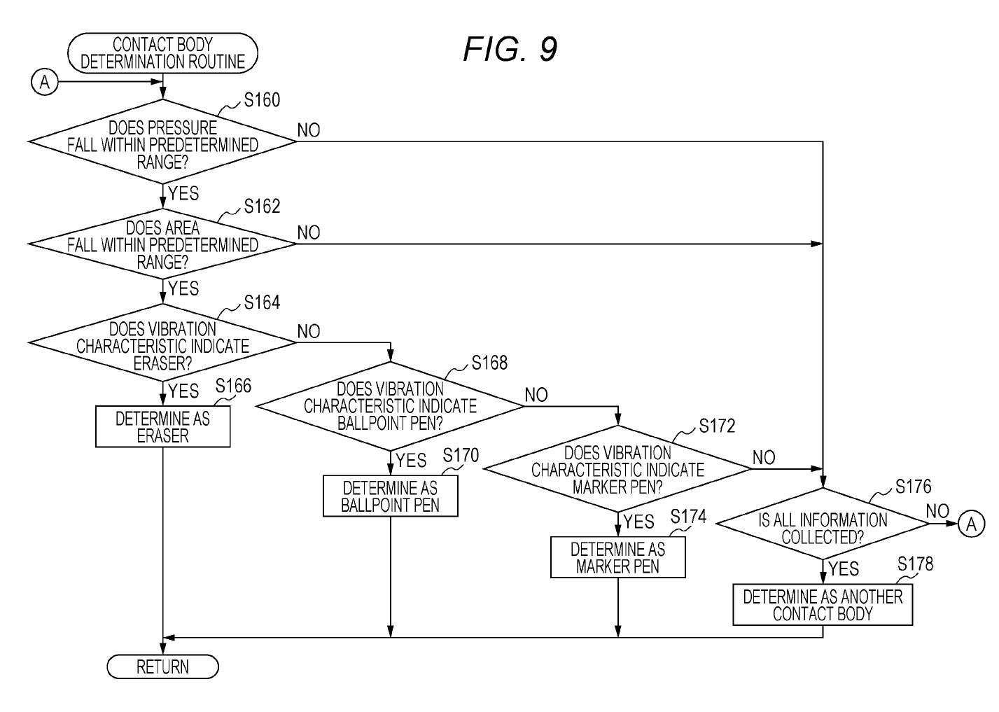

FIG. 9 shows a sub-routine for determining the kind of the contact body, providing the details of step S140 described in FIG. 6. As illustrated in FIG. 9, the control unit 11 first determines whether the contact pressure falls within a predetermined range (for example, 150 to 200 [gf]) (step S160). As a result of the determination, when the contact pressure falls within the predetermined range (step S160: YES), the process moves to step S162. In contrast, when the contact pressure is out of the predetermined range (step S160: NO), the process moves to step S176.

At step S162, the control unit 11 determines whether the contact area falls within a predetermined range (for example, 2 to 3 [mm²]). As a result of the determination, when the contact area falls within the predetermined range (step S162: YES), the process moves to step S164. In contrast, when the contact area is out of the predetermined range (step S164: NO), the process moves to step S176.

At step S164, the control unit 11 refers to the contact body determination information stored in the storage unit 11d to determine whether the characteristics of the waveform of vibrations indicated by the vibration information match the characteristics of the vibration waveform of the eraser. As a result of the determination, when the characteristics of the waveform of vibrations match the characteristics of the vibration waveform of the eraser (step S164: YES), the control unit 11 determines that the kind of the contact body 20 is the eraser and writes information indicating that the kind of the contact body 20 is the eraser into the RAM 11c or the storage unit 11d (step S166). Upon completion of step S166, the sub-routine for determining the kind of the contact body is terminated.

In contrast, when there is no match with the characteristics of the vibration waveform of the eraser (step S164: NO), the control unit 11 determines whether the characteristics of the waveform of the vibrations indicated by the vibration information match the characteristics of the vibration waveform of the ballpoint pen (step S168). As a result of the determination, when there is a match with the characteristics of the vibration waveform of the ballpoint pen (step S168: YES), the control unit 11 determines that the kind of the contact body 20 is the ballpoint pen, and writes the information indicating that the kind of the contact body 20 is the ballpoint pen into the RAM 11c or the storage unit 11d (step S170). Upon completion of step S170, the sub-routine for determining the kind of the contact body is terminated.

In contrast, when there is no match with the characteristics of the vibration waveform of the ballpoint pen (step S168: NO), the control unit 11 determines whether the characteristic of the waveform of vibrations indicated by the vibration information match the characteristics of the vibration waveform of the marker pen (step S172). As a result of the determination, when there is a match with the characteristics of the vibration waveform of the marker pen (step S172: YES), the control unit 11 determines that the kind of the contact body 20 is the marker pen, and writes the information indicating that the kind of the contact body 20 is the marker pen into the RAM 11c or the storage unit 11d (step S174). Upon completion of step S174, the sub-routine for determining the kind of the contact body is terminated.

Meanwhile, when there is no match with the characteristics of the vibration waveform of the marker pen (step S172: NO), the process moves to step S176. At step S176, the control unit 11 determines whether sufficient information is collected to determine the kind of the contact body. As a result of the determination, when sufficient information is collected to determine the kind of the contact body (step S176: YES), the control unit 11 determines that the contact body is not an eraser, a ballpoint pen, or a marker pen, and writes the information indicating the kind of the contact body 20 into the RAM 11c or the storage unit 11d (step S178). Upon completion of step S178, the sub-routine for determining the kind of the contact body is terminated.

In contrast, when no sufficient information is collected to determine the kind of the contact body (step S176: NO), the process returns to step S160 and the control unit 11 repeats the foregoing steps.

In the foregoing embodiment, the control unit 11 determines the kind of the contact body 20 based on the contact pressure and the contact area indicated by the contact information, and the vibrations indicated by the vibration information. However, the present invention is not limited to this. For example, the control unit 11 may determine the kind of the contact body 20 based on the contact area indicated by the contact information and the vibrations indicated by the vibration information. Alternatively, the control unit 11 may determine the kind of the contact body 20 based on the contact pressure indicated by the contact information and the vibrations indicated by the vibration information. From the viewpoint of determining accurately the kind of the contact body 20, however, the number of parameters for use in the determination is preferably larger, and the control unit 11 preferably determines the kind of the contact body 20 based on the three parameters of contact pressure, contact area, and vibrations.

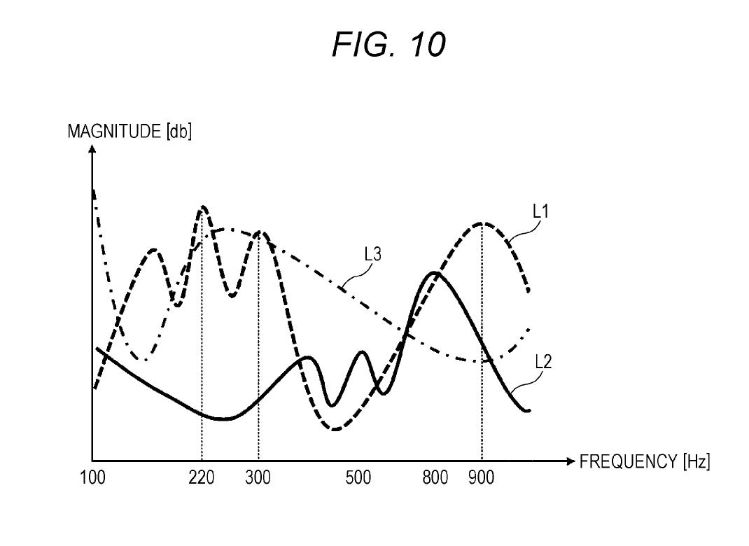

In the foregoing embodiment, the control unit 11 may perform a Fourier transform on the vibrations indicated by the vibration information, and determine the kind of the contact body 20 based on the contact pressure and the contact area indicated by the contact information and the results of the Fourier transform. In this case, the control unit 11 serves as a Fourier transform unit that performs a Fourier transform on the vibrations indicated by the vibration information. FIG. 10 is a graph in which waveforms obtained by performing a Fourier transform on the vibrations generated by the contact bodies 20 contacting the paper sheet 30 are plotted on the axes of frequency and magnitude. In FIG. 10, a dotted line L1 shows a waveform obtained by performing a Fourier transform on the vibrations generated by a ballpoint pen as the contact body 20 contacting the paper sheet 30. As shown by the dotted line L1, when the contact body 20 is a ballpoint pen, the peak frequency of the waveform obtained by performing a Fourier transform is about 220 [Hz]. In FIG. 10, a solid line L2 shows a waveform obtained by performing a Fourier transform on the vibrations generated by a marker pen as the contact body 20 contacting the paper sheet 30. As shown by the solid line L2, when the contact body 20 is a marker pen, the peak frequency of the waveform obtained by performing a Fourier transform is about 800 [Hz]. In FIG. 10, a one-dot chain line L3 shows a waveform obtained by performing a Fourier transform on the vibrations generated by an eraser as the contact body 20 contacting the paper sheet 30. As shown by the one-dot chain line L3, when the contact body 20 is an eraser, the peak frequency of the waveform obtained by performing a Fourier transform is about 250 [Hz]. As described above, the peak frequency of the waveform obtained by performing a Fourier transform on the vibrations indicated by the vibration information is a parameter that varies clearly depending on the contact bodies 20. Accordingly, the control unit 11 can determine accurately the kind of the contact body 20 by the use of the parameter.

Information on the contact body 20 other than the contact pressure, the contact area, and the vibration information, for example, characteristic movement information specific to the contact bodies may be additionally used to determine the kind of the contact body 20. The movement information may be information indicating the back-and-forth motion of an eraser, information indicating a circle written by a marker pen, or the like, for example.

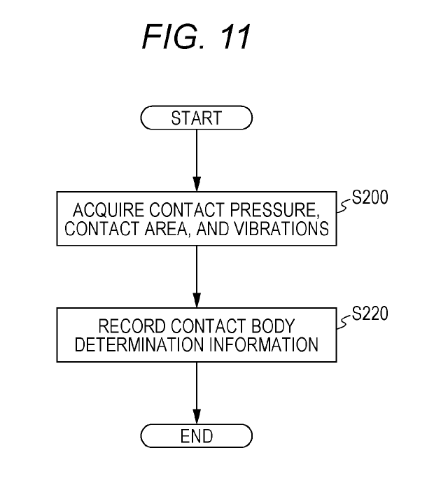

In the foregoing premise technique, to add a determinable contact body 20, the control unit 11 may record contact determination information on the contact body 20 in the storage unit 11d. For example, it is assumed that there are a first determinable contact body and a second contact body that is similar in appearance to the first contact body but has characteristics different from those of the first contact body. In this case, the second contact body is brought into contact with the input surface of the touch panel 13 or the paper sheet 30 placed on the input surface and moved over the same to acquire vibration information specific to the second contact body and store the same in the storage unit 11d, thereby adding the new determinable contact body. FIG. 11 is a flowchart of a process for adding a contact body executed by the control unit 11. This process is executed by, for example, after power-on of the handwriting input device 10, accepting the user's operation for adding the contact body 20, more specifically, the user's operation for inputting the contact information and the vibration information. First, the control unit 11 acquires the contact information indicating the contact pressure and the contact area of the contact body 20 to be added on the input surface of the touch panel 13 and the vibration information indicating the characteristics of vibrations generated by the contact of the contact body 20 (step S200). Then, the control unit 11 records in the storage unit 11d the contact body determination information in which the acquired contact information and vibration information are associated with each other (step S220). The control unit 11 may be configured to determine whether the kind of the contact body to be added is determinable from the kinds of the contact bodies already determinable and notify the user of the determination result by a message or sound.

### Second Embodiment

Next, the characteristics of the handwriting input device 10 in a second embodiment will be described. Unlike in the first embodiment, in the second embodiment, the handwriting input device 10 has the function of determining the kind of the contact body 20 taking into account the vibration characteristics of making differences in the vibration information detected by the vibration detection unit 14 depending on differences in distance between the contact position of the contact body 20 on the input surface of the touch panel 13 and the vibration detection unit 14. This function makes it possible to determine the kind of the contact body 20 more accurately as compared to the premise technique not taking the vibration characteristics into account.

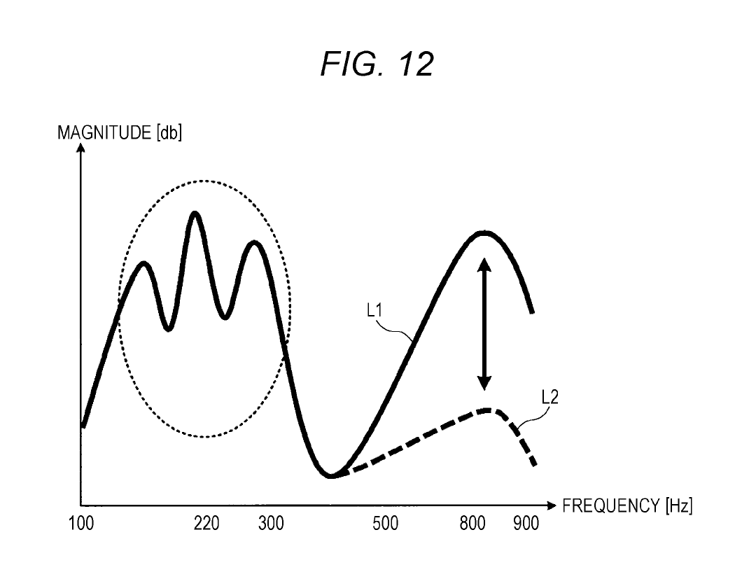

The vibration characteristics will be specifically described. FIG. 12 is an example of a graph in which, when the contact body 20 is a pen such as a ballpoint pen, a felt-tip pen, or a lead pencil, waveforms obtained by performing a Fourier transform on vibrations generated by one and the same contact body 20 contacting the paper sheet 30 (hereinafter, referred to as spectrum waveforms) are plotted on the axes of frequency and magnitude. In the graph, a solid line L1 shows a waveform in which the distance between the contact position of the contact body 20 on the input surface of the touch panel 13 and the vibration detection unit 14 is short, whereas a dotted line L2 shows a waveform in which the distance between the contact position of the contact body 20 on the input surface of the touch panel 13 and the vibration detection unit 14 is long. As shown by the solid line L1 and the dotted line L2, in a high-frequency range (for example, 500 [Hz] or more), the waveform changes depending on the difference in distance between the contact position of the contact body 20 and the vibration detection unit 14, whereas in a low-to-medium frequency range surrounded by a dotted line in FIG. 12 (for example, the range of 100 to 300 [Hz]), the waveform hardly changes depending on the difference between the contact position of the contact body 20 and the vibration detection unit 14. As described above, it is possible to determine accurately whether the kind of the contact body 20 is any of the pens by recognizing the characteristics of the waveform in the low-to-medium frequency range, regardless of the distance between the contact position of the contact body 20 and the vibration detection unit 14.

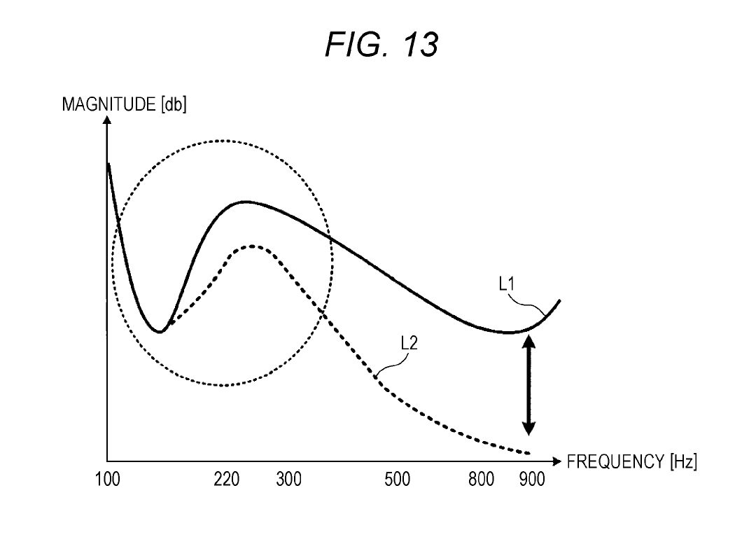

FIG. 13 is a graph in which, when the contact body 20 is an eraser, waveforms obtained by performing a Fourier transform on vibrations generated by one and the same contact body 20 contacting the paper sheet 30 are plotted on the axes of frequency and magnitude. In the graph, a solid line L1 shows the waveform in which the distance between the contact position of the contact body 20 on the input surface of the touch panel 13 and the vibration detection unit 14 is short, whereas a dotted line L2 shows the waveform in which the distance between the contact position of the contact body 20 on the input surface of the touch panel 13 and the vibration detection unit 14 is long. As shown by the solid line L1 and the dotted line L2, in a high-frequency range (for example, 500 [Hz] or more), the waveform, more specifically, the amount of attenuation changes largely depending on the differences in distance between the contact position of the contact body 20 and the vibration detection unit 14, and also in a low-to-medium frequency range (for example, 100 to 300 [Hz]) surrounded by a dotted line in FIG. 13, the peak position of the spectrum is shifted and the curve shape of the same is changed. Accordingly, in the low-to-medium frequency range, there is no longer the correlation between the contact body 20 and the vibration detection unit 14 with a change in the distance between the two, unlike in the case of the pen described above. As described above, by determining whether the waveform in the high-frequency range changes largely and checking the shape change in the low frequency range, it is possible to determine accurately whether the kind of the contact body 20 is the eraser.

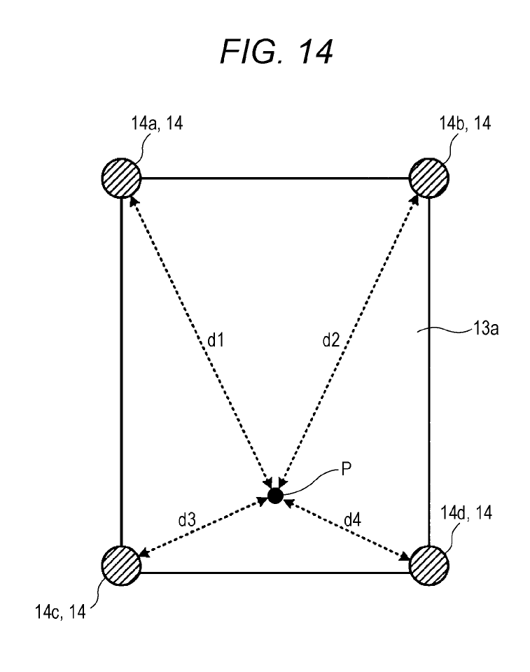

FIG. 14 is a diagram showing the arrangement of the vibration detection units 14 according to the second embodiment. As illustrated in FIG. 14, a vibration detection unit 14a is arranged at the upper left part of the outer periphery of the input surface 13a of the touch panel 13. A vibration detection unit 14b is arranged at the upper right part of the outer periphery of the input surface 13a of the touch panel 13. A vibration detection unit 14c is arranged at the lower left part of the outer periphery of the input surface 13a of the touch panel 13. A vibration detection unit 14d is arranged at the lower right part of the outer periphery of the input surface 13a of the touch panel 13.

As described above with reference to FIG. 12, when the contact body 20 is any of the pens, in the high-frequency range of spectrum waveforms obtained from the results of determination by the vibration detection units 14a to 14d, the spectrum waveforms change in shape depending on differences in distances d1 to d4 between a contact position P of the contact body 20 and the vibration detection units 14a to 14d. Meanwhile, in the low-to-medium frequency range of the spectrum waveforms obtained from the results of determination by the vibration detection units 14a to 14d, the spectrum waveforms hardly change in shape depending on differences in the distances d1 to d4 between the contact position P of the contact body 20 and the vibration detection units 14a to 14d. Accordingly, by checking the characteristics of the spectrum waveforms in the low-to-medium frequency range regardless of the distances between the contact position P of the contact body 20 and the vibration detection units 14a to 14d, it is possible to determine accurately which of the pens the kind of the contact body 20 is.

As described above with reference to FIG. 13, when the contact body 20 is an eraser, in the high-frequency ranges of spectrum waveforms obtained from the results of determination by the vibration detection units 14a to 14d, the spectrum waveforms change largely in shape depending on differences in the distances d1 to d4 between the contact position P of the contact body 20 and the vibration detection units 14a to 14d. The amounts of the changes are larger than the amounts of changes in the shape of the spectrum waveforms depending on the differences in the distances d1 to d4 between the contact position P of the contact body 20 and the vibration detection units 14a to 14d in the high-frequency range when the contact body 20 is any of the pens. Also in the low-to-medium frequency range of the spectrum waveforms obtained from the results of detection by the vibration detection units 14a to 14d, the spectrum waveforms changes in shape depending on the differences in the distances d1 to d4 between the contact position P of the contact body 20 and the vibration detection units 14a to 14d, with a lower correlation among the spectrum patterns. Accordingly, by determining whether the waveforms in the high-frequency range change largely in shape and checking the shape changes in the low frequency range depending on the distances d1 to d4 between the contact position P of the contact body 20 and the vibration detection units 14a to 14d, it is possible to determine accurately whether the kind of the contact body 20 is the eraser.

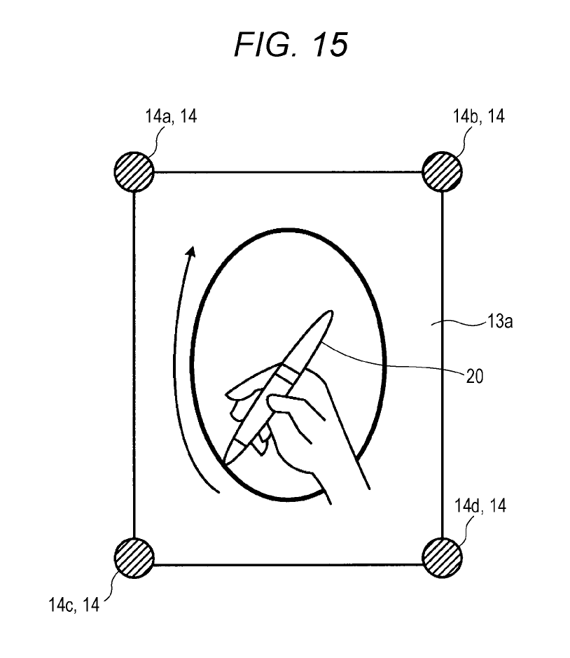

In this embodiment, to determine the kind of the contact body 20 taking the vibration characteristics into account, the storage unit 11d stores in advance for each of the contact bodies 20, spectrum waveform information based on the vibration information detected by the vibration detection units 14a to 14d when the first information is input into the input surface 13a of the touch panel 13 by the use of the contact body 20, and contact body characteristic information including the characteristic information specific to the contact body 20 relating to the vibration information. The inputting of the first information refers to, as illustrated in FIG. 15, bringing the contact body 20 into contact with the input surface 13a of the touch panel 13 and moving the same continuously through the vicinities of the vibration detection units 14a to 14d to draw a figure (a circle in FIG. 15), thereby generating the vibration information from the vibration detection units 14a to 14d and generating the contact position information on the contact body from the touch panel 13. While the contact body 20 is used to draw the circle on the input surface 13a, the vibration detection units 14a to 14d detect vibrations generated by the contact body 20 contacting the input surface 13a, and output the detected vibrations as vibration information to the control unit 11. While the contact body 20 is used to draw the circle on the input surface 13a, the touch panel 13 detects the contact positions of the contact body 20 on the input surface 13a, more specifically, the successive positions of the contact body 20 forming the circle drawn by the contact body 20, and outputs the same to the control unit 11. The storage unit 11d serves as a contact body characteristic information storage unit.

The control unit 11 also serves as an additional storage unit. To add a new determinable contact body 20, the control unit 11 generates new contact body characteristic information and stores the same in the storage unit 11d. More specifically, the control unit 11 first performs a Fourier transform on the vibrations indicated by the vibration information output from the vibration detection units 14a to 14d to acquire spectrum waveforms. Then, the control unit 11 generates first characteristic information in which the distance d1 between the vibration detection unit 14a and the contact position P output from the touch panel 13 and the spectrum waveform based on the vibrations detected by the vibration detection unit 14a corresponding to the contact position P are associated with each other. The control unit 11 also generates second characteristic information in which the distance d2 between the vibration detection unit 14b and the contact position P output from the touch panel 13 and the spectrum waveform based on the vibrations detected by the vibration detection unit 14b corresponding to the contact position P are associated with each other. The control unit 11 also generates third characteristic information in which the distance d3 between the vibration detection unit 14c and the contact position P output from the touch panel 13 and the spectrum waveform based on the vibrations detected by the vibration detection unit 14c corresponding to the contact position P are associated with each other. The control unit 11 also generates fourth characteristic information in which the distance d4 between the vibration detection unit 14d and the contact position P output from the touch panel 13 and the spectrum waveform based on the vibrations detected by the vibration detection unit 14d corresponding to the contact position P are associated with each other.

Next, the control unit 11 combines the first characteristic information, the second characteristic information, the third characteristic information, and the fourth characteristic information, and sorts the spectrum waveforms by the distances between the vibration detection units 14a to 14d and the contact position P to generate spectrum waveform information (equivalent to the vibration information) in which the spectrum waveforms are aligned at predetermined spacings.

Next, the control unit 11 refers to the spectrum waveforms included in the spectrum waveform information to extract a high frequency range with a high correlation, more specifically, a high frequency range with a high degree of similarity among the waveforms. The control unit 11 then sets the extracted frequency range as characteristic information specific to the contact body 20. The control unit 11 then associates the spectrum waveform information with the set characteristic information to generate contact body characteristic information.

To store additionally the generated contact body characteristic information in the storage unit 11d, the control unit 11 determines whether there is a correlation between the spectrum waveform information included in the contact body characteristic information and the spectrum waveform information included in the contact body characteristic information already stored in the storage unit 11d, in the frequency range indicated by the characteristic information included in the generated contact body characteristic information. As a result of the determination, when there is a correlation between the two, the control unit 11 does not store additionally the generated contact body characteristic information in the storage unit 11d. This is to prevent the overlapped contents of the contact body characteristic information from being stored in the storage unit 11d. In contrast, when there is no correlation between the two, the control unit 11 stores additionally the generated contact body characteristic information in the storage unit 11d.

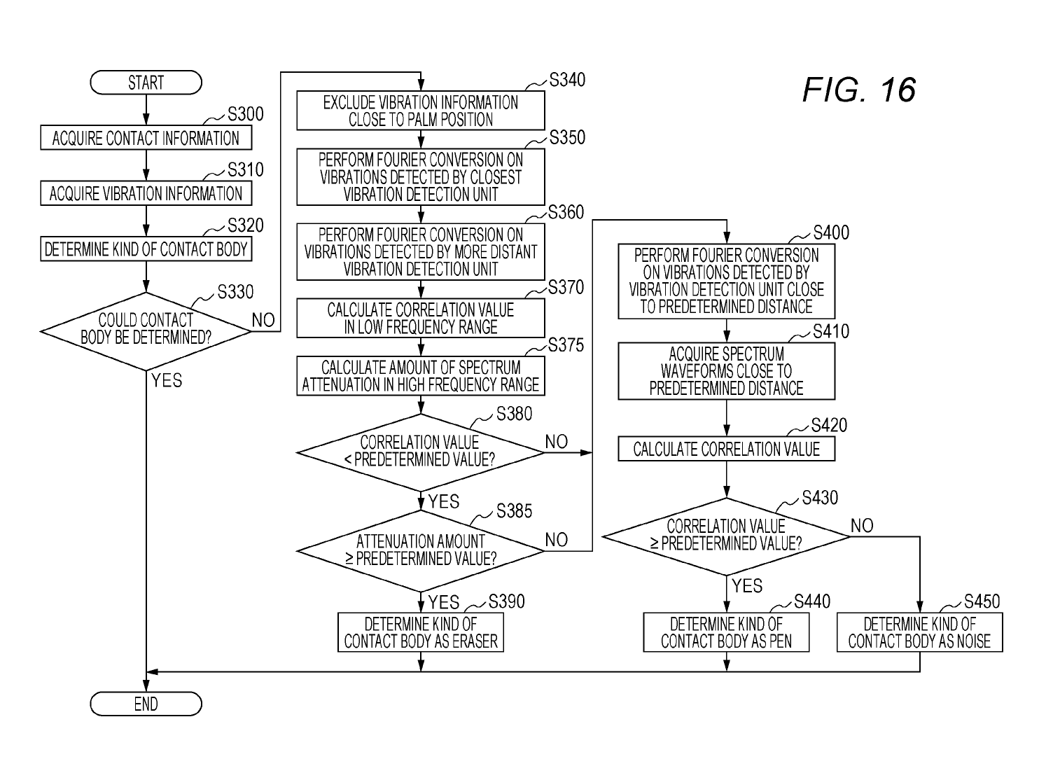

Next, descriptions will be given as to a contact body determination process for determining the kind of the contact body 20 when writing is done by the contact body 20 on the paper sheet 30 placed on the touch panel 13 in this embodiment. FIG. 16 is a flowchart of the contact body determination process executed by the control unit 11 based on the contact body determination program according to this embodiment. This process is executed each time writing is done by the contact body 20 on the paper sheet 30 after power-on of the handwriting input device 10, for example.

First, the control unit 11 acquires the contact information output from the touch panel 13 (step S300). Then, the control unit 11 acquires the vibration information output from the vibration detection units 14a to 14d (step S320).

Next, the control unit 11 executes the process for determining the kind of the contact body 20 based on the contact pressure and the contact area indicated by the contact information acquired at step S300 (step S320). When the kind of the contact body 20 can be determined (step S330: YES), the handwriting input device 10 terminates the process described in FIG. 16.

In contrast, when the kind of the contact body 20 cannot be determined (step S330: NO), the control unit 11 excludes the vibration information acquired from the vibration detection unit closest to the user's palm contacting the input surface 13a of the touch panel 13, out of the contact information acquired from the vibration detection units 14a to 14d at step S310 (step S340). This is to eliminate the influence of the vibrations generated by the user's palm contacting the input surface 13a to perform accurately the contact body determination process based on the vibration information. In this embodiment, the control unit 11 can specify the position of the user's palm based on the contact pressure and the contact area indicated by the contact information acquired at step S300.

The information on the user's dominant hand, that is, the information on whether the user is right-handed or left-handed may be set in the handwriting input device 10 such that the vibration information to be excluded will be decided according to the setting of the dominant hand. For example, when the user is right-handed, the control unit 11 excludes the contact information acquired from the vibration detection unit 14d at the lower right part of the input surface 13a of the touch panel 13. In contrast, when the user is left-handed, the control unit 11 excludes the contact information acquired from the vibration detection unit 14c at the lower left part of the input surface 13a of the touch panel 13. In addition, the information on the user's dominant hand may be automatically set at the handwriting input device 10. For example, when some information is input by the contact body 20 to the input surface 13a of the touch panel 13, the user's dominant hand may be set according to the relationship between the contact position of the contact body 20 and the position of the user's palm. For example, when the contact position of the contact body 20 is at the left side of the palm position, the user's dominant hand is set as right hand.

Next, the control unit 11 performs a Fourier transform on the vibrations indicated by the vibration information acquired from the vibration detection unit closest to the first contact position of the contact body 20 on the input surface 13a of the touch panel 13 (for example, the vibration detection unit 14c) (step S350). Then, the control unit 11 performs a Fourier transform on the vibrations indicated by the vibration information acquired from the vibration detection unit most distant from the first contact position of the contact body 20 on the input surface 13a of the touch panel 13 (for example, the vibration detection unit 14b) (step S360).

Next, the control unit 11 calculates the correlation value of the spectrum waveform obtained by the Fourier transform at step S350 and the spectrum waveform obtained by the Fourier transform at step S360 in the low frequency range (step S370). Then, the control unit 11 calculates the amount of attenuation of the spectrum waveform obtained at step S360 from the spectrum waveform obtained at step S350 in the high frequency range (step S375). Then, the control unit 11 determines whether the correlation value calculated at step S370 is smaller than a predetermined value, that is, whether the spectrum waveform in the low frequency range has changed largely depending on the distances between the contact position of the contact body 20 and the vibration detection units 14b and 14c (step S380).

When determining that the correlation value is smaller than the predetermined value (step S380: YES) and determining that the amount of spectrum attenuation in the high frequency range is equal to or more than the predetermined value (step S385: YES), the control unit 11 determines that the kind of the contact body 20 is the eraser and writes the information indicating that the kind of the contact body 20 is the eraser into the RAM 11c or the storage unit 11d (step S390). Upon completion of step S390, the handwriting input device 10 terminates the process described in FIG. 16.

In contrast, when the correlation value is not smaller than the predetermined value (step S380: YES) and the amount of attenuation is smaller than the predetermined value (step S385: NO), the control unit 11 performs a Fourier transform on the vibrations indicated by the vibration information acquired from the vibration detection unit (for example, the vibration detection unit 14a) arranged at the position where the distance from the first contact position of the contact body 20 on the input surface 13a of the touch panel 13 is shorter than a predetermined distance and closest to the predetermined distance (step S400). This is to improve the accuracy of determination of the contact body using the vibrations detected by the vibration detection unit separated at a certain distance from the first contact position of the contact body 20 because the vibration detection unit positioned closest to the first contact position of the contact body 20 may detect vibrations under the influence of the user's hand holding the contact body 20.

Then, the control unit 11 refers to the spectrum waveform information included in the contact body characteristic information on the contact bodies 20 stored in the storage unit 11d to acquire the spectrum waveform in which the distances between the vibration detection units 14a to 14d and the contact position are closest to the predetermined distance used at step S400 for each of the contact bodies 20 (step S410).

Next, the control unit 11 calculates the correlation values between the spectrum waveforms obtained by a Fourier transform at step S400 and the spectrum waveforms acquired for the contact bodies 20 at step S410, in the low-to-medium frequency range where, when the contact body 20 is a pen, waveforms with different characteristics are generated depending on the kinds of pens (step S420). Then, the control unit 11 determines whether any of the correlation values calculated at step S420 is equal to or more than a predetermined value (step S430).

When determining that any of the correlation values is equal to or more than the predetermined value (step S430: YES), the control unit 11 determines that the kind of the contact body 20 is the pen corresponding to the spectrum waveform with the highest correlation value, and writes the information indicating that the kind of the contact body 20 is the pen into the RAM 11c or the storage unit 11d (step S440). Upon completion of step S440, the handwriting input device 10 terminates the process described in FIG. 16.

In contrast, when none of the correlation values is equal to or more than the predetermined value (step S430: NO), the control unit 11 determines that the kind of the contact body 20 is noise, more specifically the user's palm or finger, and writes the information indicating that the kind of the contact body 20 is noise into the RAM 11c or the storage unit 11d (step S450). Upon completion of step S450, the handwriting input device 10 terminates the process described in FIG. 16. The flow of process described above is executed to determine the kind of the contact body 20 by the use of the contact information generated by the touch panel 13 and the plurality of pieces of vibration information generated by the plurality of vibration detection units 14. In particular, it is determined whether the contact body is an eraser by the use of two or more pieces of vibration information generated by two or more vibration detection units 14 among the plurality of vibration detection units 14 different in distance from the contact position of the contact body 20. This enhances the accuracy of determination as compared to the mode in which the kind of the contact body 20 is determined only by the contact information and the mode in which the kind of the contact body 20 is determined only by the vibration information.

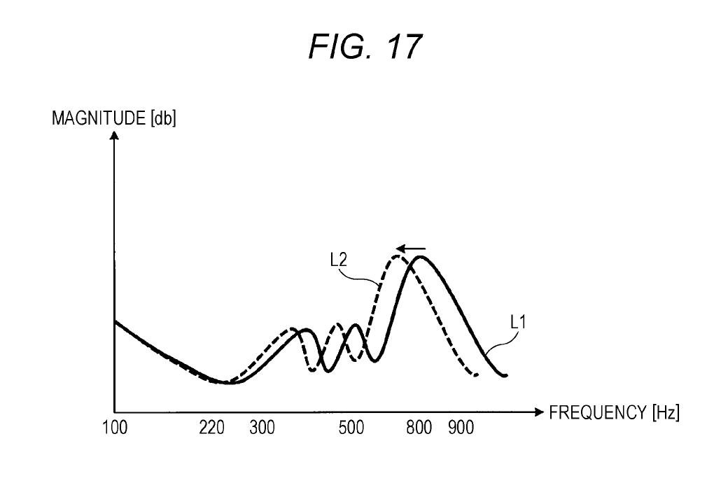

In the foregoing flow of process, the control unit 11 may determine the kind of a pen as the contact body 20 based on the correlation values of spectrum waveforms obtained by modifying the spectrum waveforms included in the contact body characteristic information depending on the use history of the contact body 20 corresponding to the contact body characteristic information and spectrum waveforms obtained by performing a Fourier transform on the vibration information detected by the vibration detection units. FIG. 17 provides spectrum waveforms obtained by performing a Fourier transform on vibrations generated by the contact body 20 as a felt pen with different use histories contacting the paper sheet 30. A solid line L1 shows a spectrum waveform with the less frequently used contact body 20, whereas a dotted line L2 shows a spectrum waveform with the more frequency used contact body 20. As shown by the solid line L1 and the dotted line L2, there is a shift in peak wavelength between the spectrum waveforms to the low frequency side. This shift occurs because, as the contact body 20 (felt pen or the like) is used increasingly, the wear of the pen tip becomes advanced and the characteristics of vibrations generated by the contact body 20 contacting the paper sheet 30 gradually change. The spectrum waveforms modified depending on the use history of the contact body 20 may be stored in advance in the storage unit 11d. At the time of calculation of the correlation values, a calculation formula for shifting (modifying) the spectrum waveform by a predetermined amount depending on the use history of the contact bodies 20 may be used to modify the spectrum waveform stored in the storage unit 11d. As described above, by determining the kind of the contact body 20 taking into account the use history of the contact body 20, it is possible to improve the accuracy of determination on which of the pens is the kind of the contact body 20.

As described above in detail, in this embodiment, the handwriting input device 10 includes: the touch panel 13 that has the input surface 13a to which information can be input by direct contact of the contact body 20 or contact of the contact body 20 via the paper sheet 30 and detects as contact information at least one of the contact pressure and the contact area of the contact body 20 on the input surface 13a; the plurality of vibration detection units 14a to 14d that is arranged on the input surface 13a at different positions to detect vibrations generated by the contact as vibration information; and the control unit 11 that selects vibration information for use in determination of the kind of the contact body 20 from the plurality of pieces of vibration information detected by the plurality of vibration detection units 14a to 14d depending on the contact position of the contact body 20 on the input surface 13a, and determines the kind of the contact body 20 based on the selected vibration information and the contact information.

According to the thus configured embodiment, when the kind of the contact body 20 is determined by the use of at least one of the contact area and the contact pressure of the contact body 20 on the input surface 13a and also the vibrations generated by the contact, preferred vibration information is selected depending on the contact position of the contact body 20 on the input surface 13a, from among the vibration information detected by the plurality of vibration detection unit 14a to 14d arranged on the input surface 13a at different positions. Accordingly, it is possible to determine more accurately the kind of the contact body 20 taking into account the characteristic of differences occurring in the vibration information detected by the vibration detection units 14a to 14d, depending on differences in distance between the contact position of the contact body 20 and the vibration detection units 14a to 14d.

In the foregoing embodiments, the control unit 11 determines the kind of the contact body 20 based on the contact pressure and the contact area indicated by the contact information and the vibrations indicated by the vibration information as an example. However, the present invention is not limited to this. For example, the control unit 11 may determine the kind of the contact body 20 based on the contact area indicated by the contact information and the vibrations indicated by the vibration information. Alternatively, the control unit 11 may determine the kind of the contact body 20 based on the contact pressure indicated by the contact information and the vibrations indicated by the vibration information. From the viewpoint of determining accurately the kind of the contact body 20, however, the number of parameters for use in the determination is preferably larger, and the control unit 11 preferably determines the kind of the contact body 20 based on the three parameters of contact pressure, contact area, and vibrations.

In the foregoing embodiments, information on the contact body 20 other than the contact pressure, the contact area, and the vibration information, for example, characteristic movement information specific to the contact bodies may be additionally used to determine the kind of the contact body 20. The movement information may be information indicating the back-and-forth motion of an eraser, information indicating a circle written by a marker pen, or the like, for example.

In the foregoing embodiments, the handwriting input device 10 includes the holding portion 15 such as a clip or the like for holding the paper sheet 30 on the input surface 13a of the touch panel 13 as an example. Alternatively, the handwriting input device 10 may be configured without the holding portion 15.

In the foregoing embodiments, the paper sheet 30 may not be a paper sheet but may be a plastic sheet or any of various recording media such as a composite material sheet of paper and plastic.

Besides, the foregoing embodiments are mere examples of modes for carrying out the present invention, and the technical scope of the present invention should not be interpreted limitedly by the foregoing embodiments. That is, the present invention can be carried out in various manners without deviating from its gist or its major characteristics.

Although embodiments of the present invention has been described and illustrated in detail, it is clearly understood that the same is by way of illustrated and example only and is not to be taken by way of limitation, the scope of the present invention being interpreted by terms of the appended claims.

What is claimed is:

1. A handwriting input device comprising:
a first detection unit that has an input surface to which inputting of information is allowed by direct contact of a contact body or contact of the contact body via a sheet and detects as contact information at least one of contact pressure and contact area of the contact body on the input surface;
a second detection unit that detects vibrations generated by the contact as vibration information; and
a contact body determination unit that determines the kind of the contact body based on the contact information and the vibration information.

2. The handwriting input device according to claim 1, wherein the second detection unit is positioned in contact with the input surface.

3. The handwriting input device according to claim 1, wherein the second detection unit is positioned in contact with the paper sheet placed on the input surface.

4. The handwriting input device according to claim 1, wherein the second detection unit is arranged at the back side of the input surface.

5. The handwriting input device according to claim 1, wherein the second detection unit is arranged at the outer periphery of the input surface.

6. The handwriting input device according to claim 1 comprising a Fourier transform unit that performs a Fourier transform on the vibrations indicated by the vibration information, wherein
the contact body determination unit determines the kind of the contact body based on the contact information and the result of the Fourier transform by the Fourier transform unit.

7. The handwriting input device according to claim 1, wherein the contact body determination unit determines the kind of the contact body based on the contact information and the waveform of the vibrations indicated by the vibration information.

8. A handwriting input device comprising:
a first detection unit that has an input surface to which inputting of information is allowed by direct contact of a contact body or contact of the contact body via a sheet and detects as contact information at least one of contact pressure and contact area of the contact body on the input surface;
a plurality of second detection units that is arranged at different positions on the input surface and detects vibrations generated by the contact as vibration information; and
a contact body determination unit that selects, from among a plurality of pieces of vibration information detected by the plurality of second detection units, two or more pieces of vibration information from two or more of the second detection units different in distance from the contact position of the contact body, according to the contact position of the contact body on the input surface, and determines the kind of the contact body based on the selected two or more pieces of vibration information and the contact information.

9. The handwriting input device according to claim 8, wherein
the contact body determination unit specifies the contact position of the user's hand on the input surface based on the contact information, and determines the kind of the contact body with exclusion of the vibration information detected by the second detection unit arranged closest to the contact position of the user's hand from the plurality of pieces of vibration information detected by the plurality of second detection units.

10. The handwriting input device according to claim 8, further comprising a contact body characteristic information storage unit that stores, for each of contact bodies, contact characteristic information including vibration information detected by the second detection unit when information was input in advance to the input surface by the use of the contact body and characteristic information specific to the contact body relating to the vibration information, wherein
the contact body determination unit executes a determination process for determining the kind of the contact body based on the contact information, and when the kind of the contact body is undetermined despite the execution of the determination process, the contact body determination unit determines the kind of the contact body based on the vibration information detected by the second detection units and the contact body characteristic information stored in the contact body characteristic information storage unit.

11. The handwriting input device according to claim 10, further comprising an additional storage unit that generates the contact body characteristic information and stores additionally the generated contact body characteristic information in the contact body characteristic information storage unit.

12. The handwriting input device according to claim 10, wherein the contact body determination unit determines the kind of the contact body, based on vibration information that is formed by modifying the vibration information included in the contact body characteristic information depending on the use history of the contact body corresponding to the contact body characteristic information and the vibration information detected by the second detection units.

13. The handwriting input device according to claim 8, wherein the second detection units are positioned in contact with the input surface.

14. The handwriting input device according to claim 8, wherein the second detection units are positioned in contact with the sheet placed on the input surface.

15. The handwriting input device according to claim 8, wherein the second detection units are arranged at the back side of the input surface.

16. The handwriting input device according to claim 8, wherein the second detection units are arranged at the outer periphery of the input surface.

17. A non-transitory recording medium storing a computer readable contact body determination program for causing a computer to perform acts comprising:
acquiring as contact information at least one of contact pressure and contact area of a contact body on an input surface to which inputting of information is allowed by direct contact of the contact body or by contact of the contact body via a sheet;
acquiring vibrations generated by the contact as vibration information; and
determining the kind of the contact body based on the contact information and the vibration information.

18. The non-transitory recording medium storing a computer readable contact body determination program according to claim 17, wherein the acquiring vibrations comprises acquiring a plurality of pieces of vibration information detected by a plurality of second detection units that are arranged at different positions on the input surface to detect vibrations generated by the contact as vibration information; and
wherein the determining comprises selecting from among the acquired plurality of pieces of vibration information two or more pieces of vibration information from two or more of the second detection units different in distance from the contact position of the contact body, according to the contact position of the contact body on the input surface, and determining the kind of the contact body based on the selected two or more pieces of vibration information and the contact information.
